(19) United States
(12) Patent Application Publication
(10) Pub. No.: US 2004/0024702 A1
(43) Pub. Date: Feb. 5, 2004

(54) CATV billing system

(75) Inventors: Amir Angel, Tel-Aviv (IL); Gil Rosen, Tel-Aviv (IL)

Correspondence Address: SUGHRUE MION, PLLC, 2100 PENNSYLVANIA AVENUE, N.W., WASHINGTON, DC, 20037, US

(73) Assignee: COMVERSE, LTD.

(21) Appl. No.: 10/207,836

(22) Filed: Jul. 31, 2002

(51) Int. Cl. G06F 17/60

(52) U.S. Cl. 705/40

(57) ABSTRACT

A method and system for effecting billing via a CATV infrastructure in respect of a service or product provided by an invoicing party to a customer, associated with whom there is a unique ID, and who is also a billing service subscriber of a billing service operated by a payment intermediary, and has a charge account details of which are known by the payment intermediary. The payment intermediary receives a billing request from the invoicing party in respect of a bill to be paid by the customer and maps the customer to a billing service subscriber. An e-bill is conveyed to the billing service subscriber via the CATV infrastructure, and upon receiving authorization from the billing service subscriber to pay the e-bill, the payment intermediary facilitates payment of the bill on behalf of the billing service subscriber.

### FIELD OF THE INVENTION

This invention relates to a billing method and system for use with cable television.

### BACKGROUND OF THE INVENTION

The increasing availability of cable television (CATV) services and the digital CATV expansion motivates the development of new services.

To process and display digital data sent over the cables, the digital CATV system uses Set-Top Boxes (STB) that are used by digital CATV subscribers (constituting CATV subscribers) to receive cable TV broadcasts.

The increased service quality and bandwidth motivates the CATV service providers to develop and provide advanced services over the network, such as the ability to pay for CATV associated services. EP 0741944 entitled “Cable television billing method” (Egendorf) assigned to Datacraft Corporation and published Jul. 4, 2001 discloses a method and system that allows a customer to utilize the existing communications link between the provider and the customer to both request and receive products and services related to the CATV service provider. The customer may typically make a request to learn more about particular products and services offered, request the delivery of a product or a service, and then interact further with the provider to tailor the delivery of the product or service to meet the customer's needs.

However, EP 0741944 does not provide any means for billing the subscriber for products and/or services that are unrelated to the CATV service. Many entities, referred to as “invoicing parties”, provide services which are periodical or continuous, such as magazines and newspapers, municipal services, water, telephone services and electricity. Other invoicing parties provide per-order services and products, such as selling furniture paid by a single or multiple payments.

Several payment methods exist for these services. For example, the customer may allow the invoicing party to directly debit his bank account (thereby risking incorrect debits identified after the money is transferred to the invoicing party), he can go to the bank to manually pay the bill (which is tedious), or he can pay by credit card in a remote payment, often by dialing a toll-free number and responding to an interactive voice response dialog by entering data via the telephone keypad (which is also a tedious process). Another increasingly popular alternative is remote payment through the Internet: The customer accesses a web site licensed by the invoicing party, where the customer inputs his/her credit card information and bill details. This last payment method is risky since the customer transmits his credit card or bank account's details (constituting the charge account) over the Internet. To use the Internet billing service, the customer also must learn how to use the computer and how to surf the Internet. Being a tedious procedure, many customers avoid using the Internet billing services, even if they are experienced web surfers.

There is a need in the art to provide for an improved method and system for providing a billing service for billing a CATV subscriber for services and products of a third party, which are different than the CATV service provider. Preferably, such a method and system should avoid transmitting the subscriber's charge account details over the CATV network (for security reasons), and be simple to learn and activate.

### SUMMARY OF THE INVENTION

It is therefore an object of the invention to allow the CATV infrastructure to be used to allow a subscriber to securely pay for third-party services that are independent of the CATV services.

This object is realized in accordance with a first aspect of the invention by a method for effecting billing, via a CATV infrastructure, the method comprising the following operations:

(a) receiving a billing request from an invoicing party that is independent of a provider of the CATV infrastructure with respect to to a bill for a product or service provided to a customer, the bill to be paid by the customer, the customer being a billing service subscriber associated with a unique ID, the billing service operated by a payment intermediary;

(b) mapping the customer to a billing service subscriber whose charge account details are known by the payment intermediary;

(c) conveying an e-bill to the billing service subscriber via the CATV infrastructure;

(d) receiving authorization from the billing service subscriber to pay the e-bill; and

(e) facilitating payment of the bill on behalf of the billing service subscriber.

The invention further provides for a method of effecting billing, via a CATV infrastructure, the method comprising the following operations:

(a) receiving an e-bill from a payment intermediary with respect to a bill for a product or service provided by an invoicing party, the bill to be paid by a customer, the customer being a billing service subscriber associated with a unique ID, the billing service operated by the payment intermediary;

(b) conveying the e-bill for display on a TV of the billing service subscriber, the payment intermediary knowing charge account details for the billing service subscriber;

responsive to an input received from the billing service subscriber, replying to the e-bill. Still further, the invention provides for a method of effecting billing, via a CATV infrastructure, the method comprising:

(i)

(a) registering with a payment intermediary a customer as a billing service subscriber with a unique ID, the billing service operated by a payment intermediary;

(b) issuing a bill request for the customer, the bill incurred with respect to a product or service rendered by an invoicing party to the customer; and

(c) conveying the bill request to the payment intermediary, the payment intermediary having charge account details of the billing service subscriber, for forwarding an e-bill to the billing service subscriber via the CATV infrastructure.

The invention also provides for a payment intermediary system to effect billing by conveying an e-bill, via a CATV infrastructure, the payment intermediary system comprising:

a processor coupled to a data repository;

an invoicing gateway coupled to the processor for receiving a billing request from an invoicing party with respect to a service or product rendered by the invoicing party to be paid by a CATV subscriber who is a billing service subscriber;

an e-billing gateway coupled to the processor for conveying to the billing service subscriber an e-bill based on the billing request;

an authorization unit coupled to the processor for receiving a reply message from the billing service subscriber and for analyzing it as authorization or rejection to pay the bill; and

a payment unit coupled to the authorization unit and responsive to said reply message being an authorization to pay the bill for facilitating payment of the bill on behalf of the billing service subscriber;

wherein charge account details of the billing service subscriber are known by the payment intermediary.

Preferably, the third-party service initiates the billing transaction so as to prompt the subscriber that payment is due and to allow him or her to effect payment via a TV STB. This may be done while the subscriber is watching television within the comfort of his or her home, requiring minimal interaction on the part of the subscriber and consequent minimal disturbance thereto.

Thus, according to the invention a third party service provider that is independent of a CATV provider may use the CATV infrastructure to invoice customers. This is distinct from hitherto proposed approaches where only the CATV provider may use the CATV infrastructure to invoice customers with respect to CATV-related services and products.

According to the invention, while using the CATV system for paying bills it is possible to avoid the security risk attendant with transmitting credit card details over the Internet.

According to one non-limiting embodiment of the invention, the billing service subscriber's charge account information, such as credit card details or bank account details (for direct debit), can be securely stored by a payment intermediary as internal data in a data repository. Subscribers, who are interested in receiving billing services according to the invention, subscribe to the payment intermediary's services and register their charge account details therewith. They receive a unique ID from the payment intermediary, to allow them to authorize billings instead of re-transmitting their credit card data for each bill. The payment intermediary securely pays bills on their behalf, using their securely stored charge account.

Invoicing parties interested in providing billing services to their customers according to the invention contract with the payment intermediary. Whenever a new bill is issued by the invoicing service, the bill is transmitted to the payment intermediary, which identifies the billing service subscriber in its data repository and transmits an e-bill to the subscriber. By receiving the subscriber approval to the payment, the intermediary service can pay the bill on behalf of the subscriber.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 shows a system for receiving CATV broadcast.

FIG. 2 is a flow chart illustrating the operations performed by the STB while processing an e-bill according to one embodiment of the invention.

FIG. 3 shows the invoicing party's billing system according to one embodiment of the invention.

FIG. 4 is a flow chart illustrating the operations taken by the invoicing party for communicating with the invoicing party according to one embodiment.

FIG. 5 illustrates an e-bill, as displayed on the subscriber's television.

FIG. 6 shows the payment intermediary system according to one embodiment of the invention.

FIG. 7 is a flow chart illustrating the operations performed by the payment intermediary.

### DETAILED DESCRIPTION OF THE INVENTION

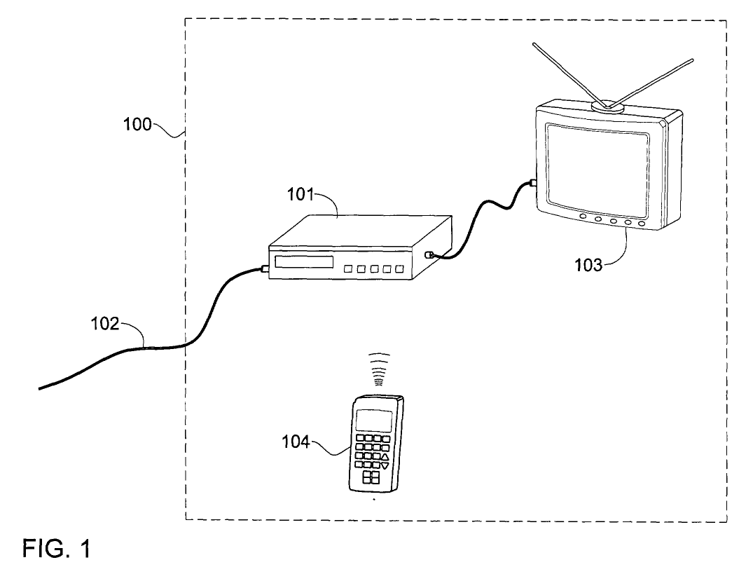

FIG. 1 shows a system 100 for receiving digital CATV broadcast. A CATV subscriber is provided with an STB (Set-Top Box) 101 coupled to the CATV service provider's cables 102 (constituting the CATV infrastructure) and to the CATV subscriber's television (TV) 103. The STB 101 is typically controlled by a remote control 104. There are other means to control the STB 101, such as a remote keyboard (not shown).

CATV supports a bi-directional communication line between the CATV service provider and the STBs. The CATV service provider broadcasts to the CATV subscribers data such as television programs, games and teletext data. Meanwhile, the CATV subscriber can interact with the CATV service provider by transmitting data via the STB 101 to the CATV service provider, for example, to select a pay-per-view movie that he wishes to watch or a game he wants to play. The STB receives data transmitted to it from the CATV service provider, decodes it and forwards the received picture (being a still image or a succession of images such as video) and/or audio to the TV 103. The STB can also encode user data (such as a movie choice) for transmission to the CATV service provider.

There are also television sets in the market that are cable-ready, i.e. the CATV subscriber does not need an STB to watch the CATV broadcasts. However, with respect to the current invention such a cable-ready TV is considered as an equivalent to a TV coupled to an STB, and therefore all references in the description to an STB apply equally to a cable-ready TV set, unless otherwise noted.

Furthermore, an STB can have a permanent unique code. For an STB that contains a smart card carrying a unique identification number, this identification number can serve as the STB's permanent unique code. An STB can have one permanent unique code, constituting a single-subscriber STB, or multiple permanent unique codes (e.g. by containing multiple smart cards), which might define a unique code for every subscriber sharing the household where the STB is installed, constituting therefore a multiple-subscriber STB.

Other embodiments refer to STBs that are programmable, for example, STBs that include flash memory, EPROM (Erasable and Programmable ROM) or EEPROM (Electrically EPROM). Such STBs can be programmed to store a programmable unique code. Unique code programming is done, for example, by the CATV service provider, which uploads the data to the STB and stores it thereon. The CATV service provider can store the programmable unique code in its internal data repository as well. Having such an embodiment, it is possible to program more than a single programmable unique code on the same STB, for example, a unique code for every subscriber sharing the household where the STB is installed, constituting therefore a multi-subscriber programmable STB. This is unlike a programmable STB which can have only a single programmable unique code, constituting therefore a single-subscriber programmable STB.

A multi-subscriber STB and a multi-subscriber programmable STB require a mechanism that supports identification of the subscriber watching at a time, in order to activate the correct permanent unique code or programmable unique code. An example for such a mechanism can be a log-on screen, displayed by the STB on start-up. The STB can display the log-on screen by request as well, to enable changing subscribers while watching. The subscriber puts his/her unique code into effect, for example, by entering a password while using the remote control. However, other embodiments may exist that enable a subscriber to activate a specific unique code, and the invention is not limited by the above exemplary embodiment.

It should be noted that all the above embodiments result in the provision of an STB, which has an effective unique code at any given instant of time. Whether the unique code is permanent or programmable does not modify the STB's functionality as such, and therefore the term STB is used hereinbelow to describe any type of STB, unless otherwise noted. The same is true concerning the unique code: the term unique code, hereinafter, refers to either a permanent or a programmable unique code, unless otherwise noted.

For a CATV subscriber having an STB with a unique code, this unique code serves to uniquely identify the CATV subscriber in a data repository managed by the CATV service provider. By such means, the CATV service provider can direct data aimed at the specific CATV subscriber by addressing this data to his STB having the unique code. Conversely, when the STB transmits data to the CATV service provider, it identifies itself using its own unique code, and therefore it identifies the CATV subscriber, too.

According to one embodiment of the invention, the CATV infrastructure can be used to provide billing services, while using the STB's unique code as a unique ID of the CATV subscriber, therefore constituting a unique ID for each billing service subscriber. Thus, the STB's unique code serves as the subscriber's digital signature. A bill sent to a CATV subscriber over the CATV infrastructure constitutes an e-bill.

Furthermore, a programmable STB can have the charge account information serving as the programmable unique code and unique ID for a subscriber. According to this embodiment, the CATV service provider must not store the charge account information in its internal data repository, as it can receive it at any time from the STB identifying itself using this unique code/charge account information. However, security considerations recommend to encrypt the data while transmitting the charge account information over the CATV infrastructure.

Hereinbelow the description refers to the embodiment of an STB identified by a unique code, which is different than the charge account information. However, this description does not limit the invention in any way.

It will be noted that according to the embodiment of the invention described herein, every billing service subscriber must be also a CATV subscriber. The opposite is not necessarily true: a CATV subscriber can opt not to subscribe to the billing service provided by the invention.

According to one embodiment of the invention, the CATV service provider can address an e-bill to a billing service subscriber, or more accurately to his STB. In turn, the STB can display the e-bill on the billing service subscriber's TV screen, so as to permit the subscriber to review the e-bill and press a button on the remote control thus replying to the e-bill by authorizing or rejecting payment. Following the subscriber's interaction, the STB encodes the e-bill's data with its own unique code for transfer to the CATV service provider. It is important to emphasize that according to this embodiment the data transferred from the STB to the CATV service provider includes only data concerning the bill and the billing service subscriber's unique ID. The billing service subscriber need not transfer his charge account details, thus contributing to the high security characterizing the invention. Also, while using a permanent unique ID, as a specific permanent unique code can be owned by only one STB, and as the CATV subscriber is registered as owning the specific STB (having the specific permanent unique code) at the CATV installation, it is assured that the billing service subscriber approved the e-bill from his own television and STB, and nobody else could do this from any other location while posing as the billing service subscriber. The same applies to a programmable STB: the CATV service provider (or another entity authorized by it) is in charge for programming the STB with a programmable unique code, and therefore the programmable unique code securely identifies the STB and the billing service subscriber.

Yet, according to this embodiment, anyone in the household of the subscriber, such as a child, could pay a bill. To ensure that only an authorized person issues the command to pay a bill, the STB can display a log-on screen at start up, even if the STB is characterized by a permanent unique code or if this is a single-subscriber programmable STB. A different embodiment can require the subscriber to enter a password while paying the e-bill. Therefore, according to the embodiments described above, the payment mechanisms can help to prevent fraud.

From the description provided so far, it is clear that a CATV service provider can serve also as a payment intermediary, and CATV subscribers who are interested in receiving the billing service can subscribe to it and become billing service subscribers. While subscribing to the billing service, according to one embodiment, the CATV service provider can use the CATV subscriber's bill paying information, such as credit card or bank account, as a charge account for the billing services. In another embodiment, the subscriber can provide a different charge account than the one used by the CATV service provider, to be used by the billing services, providing that details of the different charge account have been conveyed in advance to the billing service provider. This can be done by telephone or mail, for example.

According to yet another embodiment, an entity (a “contractor payment intermediary”) different than the CATV service provider can serve as the payment intermediary. According to such an embodiment, the contractor payment intermediary has to forward e-bills to the CATV service provider, such as by transmitting them over a computer communication network. The CATV service provider transmits the e-bills to the billing service subscribers' STBs and vice versa: the STBs transmitting the billing service subscribers' reply messages to the CATV service provider, which in turn forwards them to the contractor payment intermediary. As in the case where the payment intermediary is the CATV service provider, here also the CATV subscriber has to subscribe to the service offered by the contractor payment intermediary in order become a billing service subscriber.

It should be noted that having a contractor payment intermediary neither contributes to, nor detracts from, the method described so far where the payment intermediary is also the CATV service provider and therefore the term “payment intermediary” will be used hereinafter to describe both cases, unless otherwise noted.

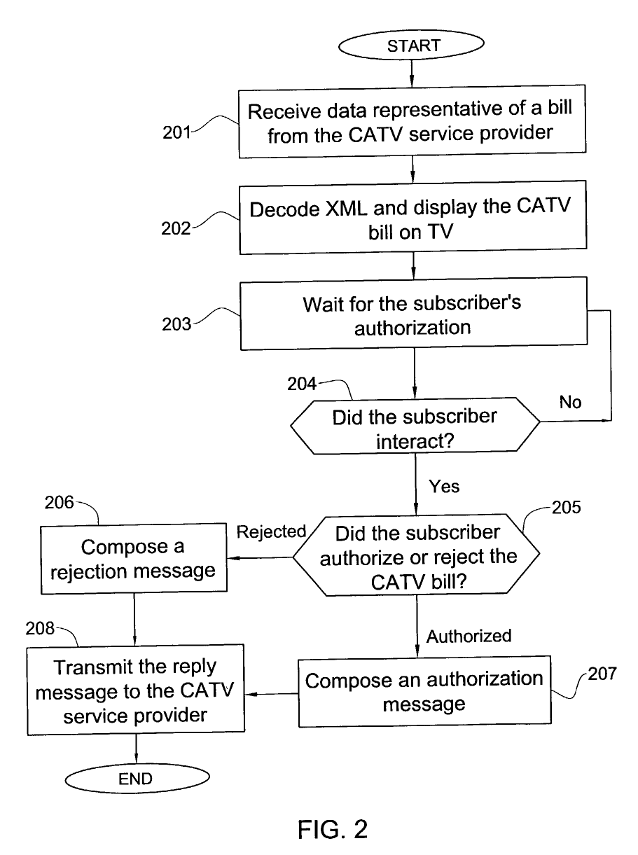

FIG. 2 is a flow chart illustrating the operations performed by the STB 101 while processing an e-bill according to one embodiment of the invention. On startup, the STB receives data representing an e-bill from the CATV service provider 201. The e-bill contains an identification string or number. According to one embodiment, the received data may be in the form of an XML message. However those versed in the art will readily appreciate that the invention is likewise applicable to any other format, language or form of messaging. The STB decodes the XML message and displays the e-bill on the subscriber's TV screen 202, giving the subscriber the options of authorizing or rejecting the e-bill, using his remote control or a suitable user interface with the STB. It should be understood that a TV screen includes a CRT, flat panel display, plasma display, projection television or equipment, home theatre apparatus, computer or any other type of screen, monitor or display capable of conveying visual information suitable for the present invention.

The authorization or rejection message constitutes a reply message. According to one embodiment, the authorization messages and the rejection messages may be differentiated by a status flag, the messages being otherwise substantially identical. The STB waits for the subscriber's interaction 203 to compose the reply message. Upon detecting such interaction 204, the STB checks whether the e-bill was authorized or rejected by the subscriber 205. If the subscriber rejects the e-bill, the STB composes a rejection message 206, which may be an XML message, including the e-bill's identification, the unique ID of the STB, and also a rejection flag. On the other hand, when the subscriber authorizes the e-bill, the STB composes an authorization message 207, which may likewise be an XML message, including the e-bill's identification, the unique ID of the STB, and also an authorization flag. The reply message (whether it is a rejection or an authorization message) is transmitted by the STB to the CATV service provider 208. The STB always physically transmits the reply messages to the CATV service provider. In those cases when a contractor payment intermediary is involved, the CATV service provider forwards the reply message to the payment intermediary, i.e. the CATV service provider is used as a gateway. That is, operation 208 has no connection to the nature of the payment intermediary, and even more generally, the nature of the payment intermediary has no influence on the operations and procedures taken by the STB.

According to the embodiment described above with reference to FIG. 2, the billing service subscriber inserts no information concerning his charge account and no such information is transmitted to the payment intermediary. However, as the payment intermediary already has the billing service subscriber's charge account details, it can retrieve it from its data repository. This notwithstanding, the present invention does not preclude the possibility of conveying information concerning the billing service subscriber's charge account, although if this is done it is obviously desirable to scramble or to encrypt it first by the TV STB.

When an invoicing party wants to join the service, providing bills to its customers through the CATV system, it first contracts the payment intermediary so as to establish a mutually agreeable communications protocol constituting a contract.

According to one embodiment, the customers of the invoicing party (constituting “customers”) are identified and mapped to respective billing service subscribers' unique IDs in the payment intermediary's data repository. By such means, each customer is mapped to a respective billing service subscriber in the data repository and constitutes a “mapped customer” who can receive the invoicing party's bills through his CATV system as e-bills. According to this embodiment, a customer who is not mapped by the payment intermediary cannot receive e-bills through the CATV system. In order to map a customer in the payment intermediary's data repository, the invoicing party has to register this customer with the payment intermediary, thereby constituting a “registered customer”. This allows customers, who wish to avoid receiving e-bills from a specific invoicing party via their TV, to ask the invoicing party not to register them or to cancel their registration. Such customers will be referred to as “unregistered customers”.

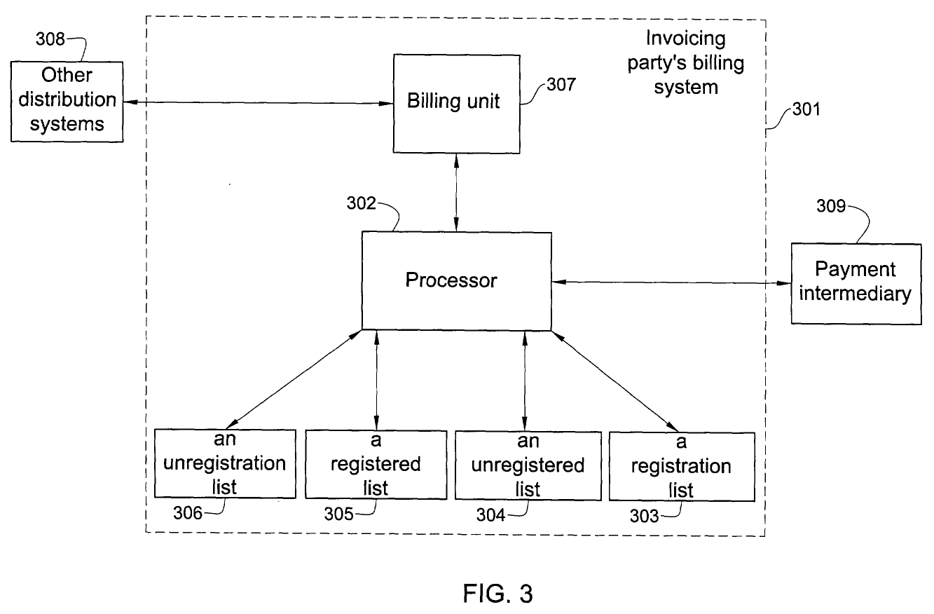

FIG. 3 shows the invoicing party's billing system 301 according to one embodiment of the invention. The invoicing party's billing system 301 is controlled by a processor 302 (constituting an invoicing party processor). The invoicing party's billing system 301 manages four repositories of customer data:

A repository 303 containing a registration list for identifying unregistered customers This list relates to customers who are not yet registered but want to receive e-bills from this invoicing party. The invoicing party's processor registers the customers listed in this repository with the payment intermediary.

A repository 304 containing a list of unregistered subscribers who do not want to receive e-bills from this invoicing party. The customers listed in this repository stay listed therein until they change their mind and request the invoicing party henceforth to direct bills to their TV. Then the invoicing party's processor 302 moves them to the registration list 303. Such an approach allows the invoicing party to determine at any instant which customers do not want to receive e-bills. The system would also operate, albeit without providing this facility, without the repository 304.

A repository 305 containing a registered list for identifying registered customers.

A repository 306 containing an unregistration list for identifying registered customers who want to stop receiving e-bills from this invoicing party. The invoicing party's processor 302 unregisters those customers from the payment intermediary and moves them to the list of unregistered subscribers 304. Again, it should be noted that these lists allow the system to operate in batch mode and provides immediate details regarding a customer's status without the need to infer it from whether or not the customer appears in the list of registered subscribers. However, they are described by way of non-limiting example and the system could work using only a list of registered subscribers. The repositories may be implemented according to one embodiment in memory, such as by managing lists of data identifying the customers. Other embodiments may implement the repositories as a single database common to all the repositories or as plural databases, wherein a database is dedicated for a repository. The databases are stored on disk or any other storage method known to those versed in the art. It should be noted that the different repositories can have different implementations. The invoicing party's billing system 301 also includes a billing unit 307. The billing unit 307 is in charge of issuing bills to customers, computing their payment due and the date of payment. The billing unit 307 can be implemented using billing tools as known to those versed in the art. A commercially available example for a billing platform is “Infranet”, which is a billing engine developed and distributed by a company named “Portal”. The billing unit 307 communicates with other distribution systems 308, external to the invoicing party's system, such as regular mail services.

Whenever the billing unit 307 issues a bill to a customer, it communicates with the invoicing party's processor 302, which checks if the customer is listed in the repository 305 of registered customers. If the customer is listed in the repository 305 of registered customers, the processor 302 issues a billing request for this customer, and transmits it to a payment intermediary 309.

It should be noted that a customer of the invoicing party who is not a billing service subscriber can nevertheless become a registered customer with the payment intermediary 309. The payment intermediary 309 is unable at this stage to map such a customer to a billing service subscriber unique ID, but stores the customer's details in its data repository. Whenever this customer becomes a billing service subscriber, the payment intermediary will locate the customer data in its data repository, and map it to the billing service subscriber's unique ID so as to allow the customer to receive e-bills from the invoicing party.

It should also be noted that a mapped customer who wishes to withdraw from receiving e-bills by the payment intermediary (i.e. unsubscribe from the billing service), can stay registered with the invoicing party. If this customer subsequently recommences his subscription to the billing service, he immediately starts receiving e-bills from the invoicing party.

While registering a customer with the payment intermediary, the registration data can vary according to the protocol established by the contract between the invoicing party and the payment intermediary. However, a customer identification string is a mandatory field. The customer identification string can be composed of any combination of characters, such as numeric characters (comprising a number), other type of characters (e.g. alphabetic characters) and combinations.

According to one embodiment, the customer identification string can be any string that serves as the customer ID at the invoicing party (such as the customer's telephone number). According to another embodiment the customer identification string can be identical to his billing service subscriber's unique ID (i.e. his STB code). However, according to this embodiment, a registered customer who is not a billing service subscriber must receive another customer identification string from the payment intermediary, even if only a temporary one, which will be changed to the billing service subscriber's unique ID when the customer later becomes a billing service subscribers. According to yet another embodiment, the customer identification string can be some other identification string, which is unique to the connection between the invoicing party and the payment intermediary.

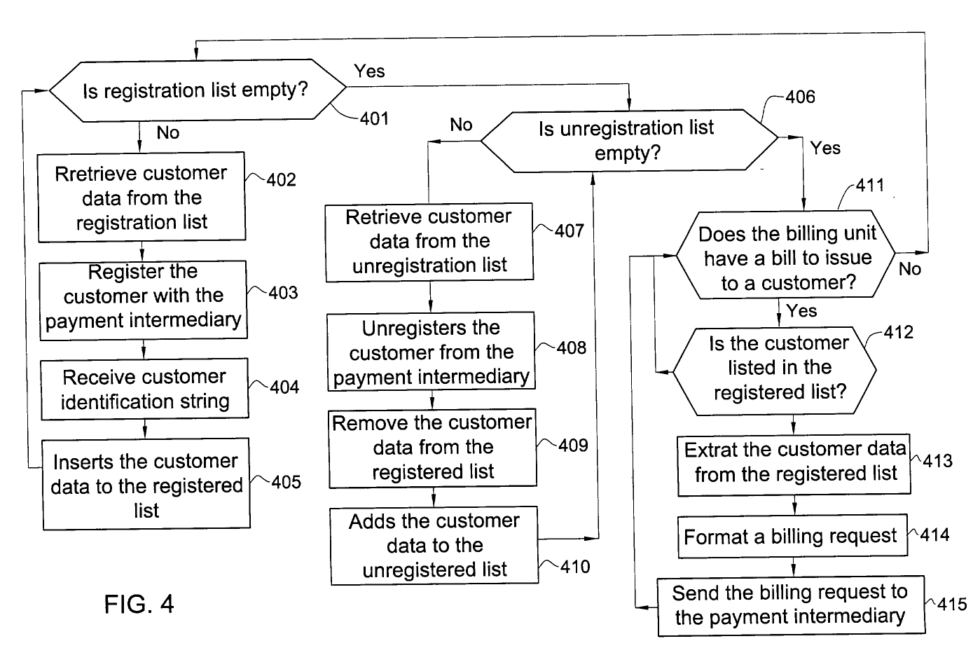

FIG. 4 is a flow chart illustrating the operations taken by the invoicing party for communicating with the payment intermediary according to one embodiment. In operation 401 the invoicing party's processor 302 checks if the registration list 303 is empty. If there are customers listed in the registration list, operation 402 retrieves data belonging to a customer from the list. In operation 403 the invoicing party's processor 302 registers the customer and his data with the payment intermediary 309, receives the agreed customer identification string for this customer from the payment intermediary (operation 404) and inserts the customer data, which includes the customer identification string, to the registered list 305(operation 405).

When the registration list 303 is empty, the invoicing party's processor 302 checks if the unregistration list 306 is empty (operation 406). If there are customers listed in the unregistration list 306, operation 407 retrieves data belonging to a customer from the list, and at operation 408 unregisters the customer from the payment intermediary by sending his customer identification string to the payment intermediary. Operation 409 removes the customer data from the registered list 305, and operation 410 adds this customer to the unregistered list.

When the unregistration list 306 is empty, operation 411 checks if the billing unit 307 has a bill to issue to a customer. If so, the invoicing party's processor 302 checks (operation 412) if the customer is listed in the registered list 305. If the customer is registered, operation 413 extracts his data from the registered list 305, operation 414 formats the billing request, and operation 415 sends a billing request to the payment intermediary.

It is important to realize that according to some embodiments, the invoicing party need not know whether a registered customer is mapped or not at the payment intermediary. According to such embodiments, the invoicing party will transmit data in respect of all its registered customer's bills to the invoicing party as well as issuing to them by other means such as mailing printed bills. In order to avoid this duplicate billing procedure, the invoicing party must distinguish between registered customers and mapped customers. This requires that there be a notification mechanism letting the invoicing party know whenever the payment intermediary maps or unmaps a customer. For example, according to one embodiment, the invoicing party's processor can poll the payment intermediary and inquire whether each of its registered customers were mapped or unmapped.

The contract between an invoicing party and a payment intermediary defines also the data fields and format transmitted by the invoicing party to the payment intermediary in order to issue an e-bill for a customer. The mandatory information for issuing an e-bill is the customer identification string and the total payment due. However, different embodiments may define other data required for issuing an e-bill, such as the listed customer's address and even data describing the bill, such as the number of telephone calls in a telephone bill, the number of items sent to the customer in another bill, or even the item's description. The e-bill may also contain recent account activity, recent bill payment information, outstanding balances, year to date billing and payment information, and the like.

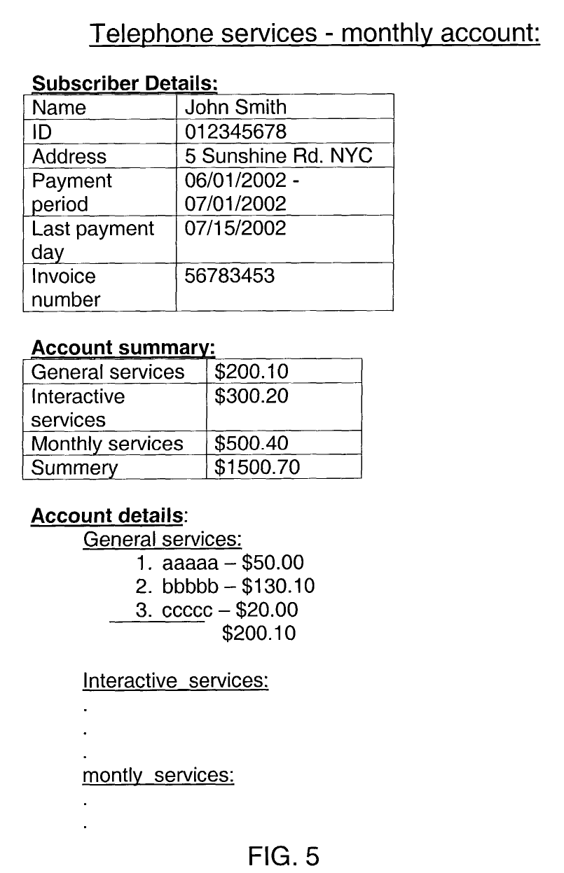

According to the bill's data in the contract between the invoicing party and the payment intermediary, the payment intermediary designs the form that will later be displayed on the subscriber's television screen. As noted above this e-bill can be implemented in XML as shown in the following example relating to the e-bill depicted in FIG. 5.

<Account>

<Subscriber_details>

<Name id=‘012345678’> John Smith </Name>
<Address street=‘5 Sunshine Rd.’ town=‘NYC’></Address>
<Last_payment_day >07/15/2002</Last_payment_day>
<Payment_period>06/01/2002 - 07/01/2002</Payment_period>
<Invoice_number >56783453</Invoice_number>

<Subscriber_details>
<Account_details_summary>

<Sum id=‘1’ name=‘general services’ units=‘dollar’>200.10</Sum >
<Sum id=‘2’ name‘interactive services’ units=‘dollar’ >300.20</Sum >
<Sum id=‘3’ name=‘monthly services’ units=‘dollar’ >500.40</Sum >
<Sum id=‘4’ name=‘sqummary’ units=‘dollar’ >1500.70</Sum >

</Account_details_summary>
<Account_details>

<Details sum=‘1’ id=‘1’ name=‘aaaaa’ units=‘dollar’>50.00</Details>
<Details sum=‘1’ id=‘2’ name=‘bbbbb’ units=‘dollar’>130.10</Details>
<Details sum=‘1’ id=‘3’ name=‘ccccc’ units=‘dollar’>20.00</Details>
<Details sum=‘2’ id=‘1’ name=... units=...> </Details>
...

</Account_details>

</Account>

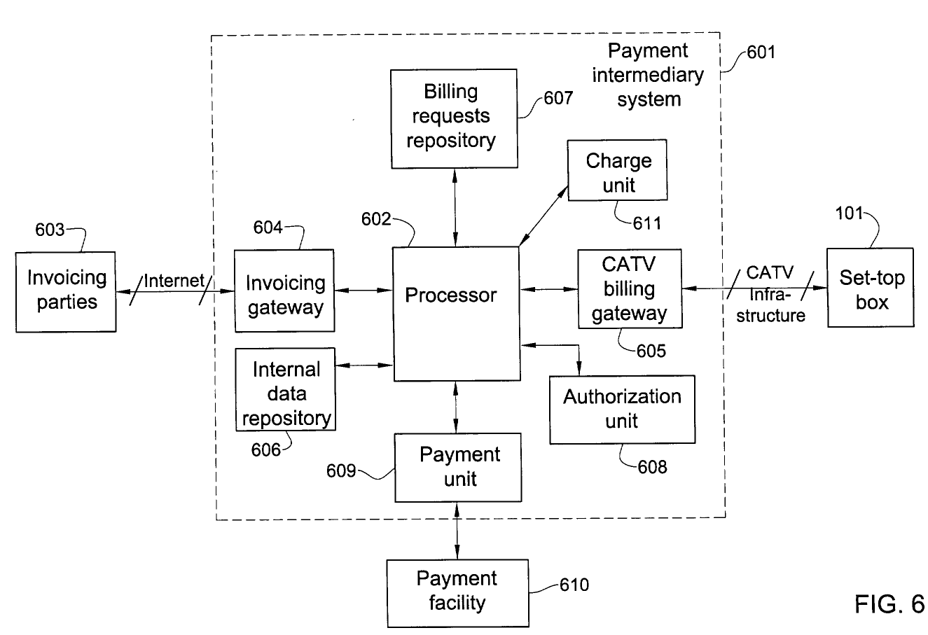

FIG. 6 shows the payment intermediary system 601 according to one embodiment of the invention. The payment intermediary system is controlled by a processor 602 (constituting a payment intermediary processor). The processor 602 connects to invoicing parties 603 by an invoicing gateway 604 and to the billing service subscribers' STBs 101 by an e-billing gateway 605 connected thereto. The billing service subscribers' STBs 101 are coupled to the e-billing gateway 605 by the CATV infrastructure.

It will be noted that in those embodiments where the payment intermediary is also the CATV service provider, the STBs 101 may be coupled to the e-billing gateway 605 directly by the CATV infrastructure. In other embodiments, where the payment intermediary is a contractor payment intermediary, the e-billing gateway 605 is coupled by some secured form of networking (not shown) to the CATV service provider instead of connecting directly to the STBs 101 by the CATV infrastructure.

The processor 602 controls a data repository 606 used to store the billing service subscribers' unique IDs, billing service subscribers' charge account details and customers' data including their customer identification strings. It should be noted that the data repository 606 may be a secured remote repository, and it may be composed of at least one database or any other form of secured data repository. Other embodiments may also split the data repository 606 to several other data repositories, each handling at least one data kind, such as a repository dedicated only for billing service subscribers' charge accounts.

The payment intermediary communicates with invoicing parties 603 using any communication mean, such as Internet.

A billing request transmitted by the invoicing party 603 to the payment intermediary system 601 is received by the invoicing gateway 604, and passed to the processor 602 which stores it on a billing requests repository 607. The processor 602 then formats the e-bill according to the data stored in the billing requests repository 607 and in the data repository 606, gives it an e-bill ID (which should also be stored in the billing requests repository 607, together with the billing request's data) and the e-billing gateway 605 transmits the e-bill to the billing service subscriber's STB 101. It should be noted that the billing requests repository 607 can be a separate database or any other form of storage dedicated to billing requests, or it can be implemented together with the data repository 606, forming together a single data storage. The payment intermediary system 601 may transmit the e-bill to the billing service subscriber's STB 101 immediately, or depending on the date of payment or other payment information regarding the e-bill, or depending on the contract with the invoicing party, the e-bill may be transmitted at some future date.

When a billing service subscriber authorizes or rejects an e-bill, the reply message is transmitted by his STB 101 to the CATV gateway 605, which further transmits it to the processor 602. The processor than passes the reply message and the respective billing request (stored in the billing requests repository 607 and identified according to the e-bill ID) to an authorization unit 608, which decodes and analyzes the reply message. In those cases when the authorization unit finds that the reply message is an authorization message, the bill request together with the billing service subscriber's charge account details (stored in the data repository 606) are forwarded to a payment unit 609.

The payment unit 609 can communicate with an external payment facility 610, such as a bank, a credit card company or an Internet payment facility for paying the bill to the invoicing party on behalf of the billing service subscriber, debiting his charge account. Alternatively, the payment unit 609 can convey the billing service subscriber's data, including his charge account, to the invoicing party for debiting his charge account.

The payment intermediary can levy a one-time fee when a CATV subscriber newly subscribes to the billing service. It may also levy to the billing service subscriber a periodic service charge, which may have a fixed component as well as a variable component, that is a function of the number of e-bills conveyed thereto. Additionally or alternatively, the payment intermediary may levy a contracting fee for contracting with an invoicing party, and/or levy a registration fee to the invoicing party for registering a customer, and/or levy a billing fee to the invoicing party for every billing request. The charge unit 611 is responsible for levying the fees and charges to the billing service subscribers and to the invoicing parties.

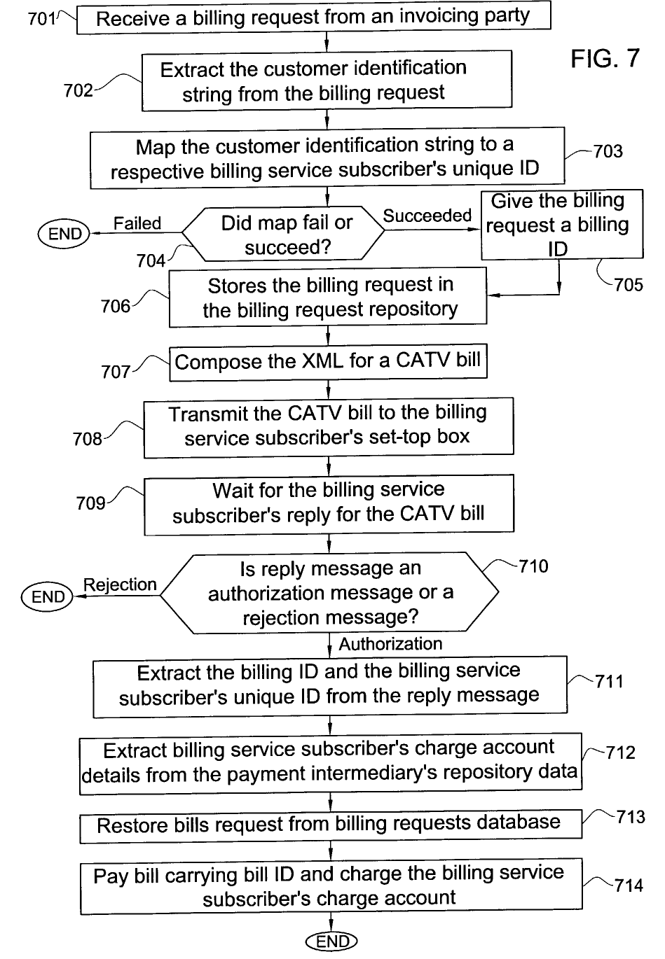

FIG. 7 is a flow chart illustrating the operations performed by the payment intermediary while issuing an e-bill to a billing service subscriber on the arrival of an invoicing party's billing request, according to one embodiment. In operation 701 a billing request is received from an invoicing party 603, and the payment intermediary's processor 602 extracts a customer identification string therefrom (operation 702). Operation 703 maps the customer identification string to a respective billing service subscriber's unique ID. The processor 602 checks if the map failed or succeeded (operation 704). The map fails when the customer identified by the customer identification string is not a billing service subscriber. In those cases when the map fails, the flow terminates. According to other embodiments (not shown), the processor 602 may notify the invoicing party 603 that it could not format and forward the e-bill, and possibly also the reason therefor.

When the map succeeds, the processor 602 gives the billing request an e-bill ID (operation 705), and stores the billing request in the billing request repository 607 (operation 706). Next operation 707 composes the XML for an e-bill, embedding in it at least part of the data transmitted to the payment intermediary in the billing request, the e-bill ID and the billing service subscriber's unique ID. Operation 708 transmits the e-bill to the billing service subscriber's STB 101.

Now the payment intermediary's processor 602 should wait (operation 709) for the billing service subscriber's reply for the e-bill. Since the reply message can be either an authorization message or a rejection message, in operation 710 the authorization unit 608 checks the character of the reply message. The differentiation between an authorization and a rejection message can be achieved by means of a flag in the reply message, having different values for authorization and rejection, respectively.

When a billing service subscriber rejects an e-bill, the authorization unit 608 terminates handling the invoicing party's billing request for the respective bill. Alternatively, it may notify the invoicing party that the customer rejected the bill.

When the billing service subscriber authorizes the e-bill, in operation 711 the authorization unit 608 extracts the e-bill ID and the billing service subscriber's unique ID from the reply message.

The billing service subscriber's unique ID extracted by operation 711 is used by operation 712 to query the internal data 605 for the billing service subscriber's charge account details. The e-bill ID extracted in operation 711 is used by operation 713 to restore the respective billing request from the billing requests repository 607.

Finally, the payment unit 609 pays the bill on behalf of the billing service subscriber (operation 714), by debiting the subscriber's charge account Alternatively, the payment unit 609 can convey the subscriber's charge account data to the invoicing party for debiting the subscriber's charge account (not shown).

It will be noted that according to the described embodiment a CATV service provider might automatically subscribe all its CATV subscribers to the billing service. However, limiting the billing service only to those CATV subscribers who voluntarily subscribe to it provides a higher degree of privacy for the CATV subscribers.

It should be noted also that, for simplicity, the description referred mainly to credit card payments. Those versed in the art will readily appreciate that the embodiments described are likewise applicable to many other payment methods and charge accounts, such as bank account's details.

It will also be understood that the system according to the invention may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

In the method claims that follow, alphabetic characters and Roman numerals used to designate claim operations are provided for convenience only and do not imply any particular order of performing the operations.

The foregoing description of the invention is for illustration, not limitation, of the invention. The scope of the invention is as set forth in the claims that follow.

1. A method of effecting billing via a CATV infrastructure, the method comprising:
(a) receiving a billing request from an invoicing party, which invoicing party is not a CATV service provider, with respect to a bill for a product or service provided to a customer, the bill to be paid by the customer, the customer being a billing service subscriber associated with a unique ID, the billing service operated by a payment intermediary;
(b) mapping the customer to the billing service subscriber whose charge account details are known by the payment intermediary;
(c) conveying an e-bill to the billing service subscriber via the CATV infrastructure;
(d) receiving authorization from the billing service subscriber to pay the e-bill; and
(e) facilitating payment of the bill on behalf of the billing service subscriber.

2. The method according to claim 1, wherein the unique ID is a unique code of a Set-Top Box used by the billing service subscriber.

3. The method according to claim 1, wherein the payment intermediary is a CATV service provider of the billing service subscriber.

4. The method according to claim 3, wherein the charge account is an account maintained by the payment intermediary with respect to CATV service.

5. The method according to claim 3, wherein the charge account is a different account than the account maintained by the payment intermediary with respect to the CATV service.

6. The method according to claim 1, wherein the payment intermediary is a contractor payment intermediary.

7. The method according to claim 1, further including levying a periodic service charge to the billing service subscriber.

8. The method according to claim 1, further including levying a service charge to the billing service subscriber for every e-bill conveyed to him.

9. The method according to claim 1, further including levying a one-time fee to the CATV subscriber on subscribing to the billing service.

10. The method according to claim 1, wherein the charge account is chargeable by the payment intermediary and operation (b) includes:
(i) paying the bill to the invoicing party on behalf of the billing service subscriber; and
(ii) debiting the billing service subscriber's charge account.

11. The method according to claim 1, wherein operation (b) includes:
(i) extracting from a data repository billing service subscriber data that includes said details of the charge account; and
(ii) conveying the billing service subscriber data to the invoicing party for debiting the billing service subscriber's charge account.

12. A method of effecting billing via a CATV infrastructure, the method comprising:
(a) receiving an e-bill from a payment intermediary with respect to a bill for a product or service provided by an invoicing party, which invoicing party is not a CATV service provider, the bill to be paid by a customer, the customer being a billing service subscriber associated with a unique ID, the billing service operated by the payment intermediary;
(b) conveying the e-bill for display on a TV of the billing service subscriber, the payment intermediary knowing charge account details for the billing service subscriber;
(c) responsive to an input received from the billing service subscriber, replying to the e-bill.

13. The method according to claim 12, wherein the reply message is an authorization message.

14. The method according to claim 12, wherein the reply message is a rejection message.

15. The method according to claim 12 wherein the e-bill received by the Set-Top Box is an XML message.

16. The method according to claim 12, wherein the reply message conveyed by the Set-Top Box is an XML message.

17. A method of effecting billing via a CATV infrastructure, the method comprising:
(a) registering with a payment intermediary a customer as a billing service subscriber with a unique ID, the billing service operated by a payment intermediary;
(b) issuing a bill request for the customer, the bill incurred with respect to a product or service rendered by an invoicing party to the customer, which invoicing party is not a CATV service provider; and
(c) conveying the bill request to the payment intermediary, the payment intermediary having charge account details of the billing service subscriber, for forwarding an e-bill to the billing service subscriber via the CATV infrastructure.

18. The method according to claim 17, further comprising:
unregistering a customer from the payment intermediary with respect to a specified invoicing party from which the customer does not wish to receive e-bills.

19. A payment intermediary system to effect billing by conveying an e-bill via a CATV infrastructure, the payment intermediary system comprising:
a processor coupled to a data repository;
an invoicing gateway coupled to the processor for receiving a billing request from an invoicing party, which invoicing party is not a CATV service provider, with respect to a service or product rendered by the invoicing party to be paid by a CATV subscriber who is a billing service subscriber;
an e-billing gateway coupled to the processor for conveying to the billing service subscriber an e-bill based on the billing request;
an authorization unit coupled to the processor for receiving a reply message from the billing service subscriber and for analyzing it as authorization or rejection to pay the bill; and
a payment unit coupled to the authorization unit and responsive to said reply message being an authorization to pay the bill for facilitating payment of the bill on behalf of the billing service subscriber;
wherein charge account details of the billing service subscriber are known by the payment intermediary.

20. The payment intermediary system according to claim 19, further including a charge unit coupled to the processor for levying a periodic service charge against the billing service subscriber's charge account.

21. The payment intermediary system according to claim 19, further including a charge unit for levying a billing fee to the invoicing party for every billing request.

22. A program storage medium readable by machine, embodying a program of instructions to effect billing via a CATV infrastructure, the instructions operable for providing instructions comprising:
(a) receiving a billing request from an invoicing party, which invoicing party is not a CATV service provider, with respect to a product or service rendered by the invoicing party to a customer who is a billing service subscriber of a billing service operated by a payment intermediary, the billing service subscriber associated with a unique ID, the payment intermediary knowing charge account details of the billing service subscriber;
(b) mapping the customer to the billing service subscriber;
(c) conveying an e-bill to the billing service subscriber via the CATV infrastructure; and
(d) facilitating payment of the bill on behalf of the billing service subscriber responsive to authorization of the billing service subscriber.

23. A computer readable medium having a program of instructions embodied therein to effect billing via a CATV infrastructure, the program of instructions comprising:
instructions configured to receive a billing request from an invoicing party, which invoicing party is not a CATV service provider, with respect to a bill to be paid by a customer with respect to a product or service rendered by an invoicing party to the customer, the customer being a billing service subscriber associated with a unique ID, the billing service operated by a payment intermediary having billing service subscriber charge account details;
instructions configured to map the customer to the billing service subscriber;
instructions configured to convey an e-bill to the billing service subscriber via the CATV infrastructure; and
instructions configured to respond to authorization of the billing service subscriber to facilitate payment of the bill on behalf of the billing service subscriber.

24. A machine readable medium embodying a program of instructions for effecting billing via a CATV infrastructure, the program of instructions comprising:
(a) receiving an e-bill from a payment intermediary with respect to a bill to be paid by a customer for a products or service product rendered by an invoicing party to the customer, which invoicing party is not a CATV service provider, the customer being a billing service subscriber associated with a unique ID, the billing service operated by a payment intermediary having billing service subscriber charge account details;
(b) conveying the e-bill for display on a TV of the billing service subscriber;
(c) responsive to an input received from the billing service subscriber, means for composing a reply message in respect of the e-bill; and
(d) conveying the reply message to the payment intermediary.

25. A computer-readable medium having a program of instructions embodied therein for effecting billing via a CATV infrastructure, the program of instructions comprising:
instructions configured to receive an e-bill from a payment intermediary with respect to a bill to for a service or product rendered by an invoicing party to a customer, which invoicing party is not a CATV service provider, the customer being a billing service subscriber associated with a unique ID, the billing service operated by a payment intermediary having billing service subscriber charge account details;
instructions configured to convey the e-bill for display on a TV of the billing service subscriber;
instructions configured responsive to an input received from the billing service subscriber to compose a reply message in respect of the e-bill; and
instructions configured to convey the reply message to the payment intermediary.

26. A machine-readable medium embodying a program of instructions for effecting billing via a CATV infrastructure comprising:
(a) registering a customer with a payment intermediary for billing with respect to a service or product rendered by an invoicing party to the customer, which invoicing party is not a CATV service provider, the customer being a billing service subscriber associated with a unique ID, the billing service operated by a payment intermediary having billing service subscriber charge account;
(b) issuing a bill request for the customer; and
(c) conveying the bill request to the payment intermediary for forwarding an e-bill to the billing service subscriber via the CATV infrastructure.

27. A machine-readable medium having a program of instructions embodied therein for effecting billing via a CATV infrastructure, the computer program product comprising:
instructions configured to register a customer with a payment intermediary with respect to billing for a service or product rendered by an invoicing party to the customer, which invoicing party is not a CATV service provider, the customer being a billing service subscriber associated with a unique ID, the billing service operated by a payment intermediary having billing service subscriber charge account details;
instructions configured to issue a bill request for the customer; and
instructions configured to convey the bill request to the payment intermediary for forwarding an e-bill to the billing service subscriber via the CATV infrastructure.

28. A payment intermediary system of effecting billing by conveying an e-bill via a CATV infrastructure with respect to a service or product provided by an invoicing party, which invoicing party is not a CATV service provider, to a CATV subscriber who is a billing service subscriber and has a charge account details of which are known by the payment intermediary, the payment intermediary system comprising:
a processor coupled to a data repository;
an invoicing gateway coupled to the processor for receiving a billing request from the invoicing party in respect of a bill to be paid by the billing service subscriber;
an e-billing gateway coupled to the processor for conveying to the billing service subscriber an e-bill relating to the bill;
an authorization unit coupled to the processor for receiving a reply message from the billing service subscriber and for analyzing it as authorization or rejection to pay the bill; and
a payment unit coupled to the authorization unit and responsive to said reply message being an authorization to pay the bill for facilitating payment of the bill on behalf of the billing service subscriber.

29. A method of effecting billing via a CATV infrastructure, the method comprising:
(a) receiving from a payment intermediary an e-bill incurred with respect to a product or service rendered by an invoicing party, which invoicing party is not a CATV service provider, to a customer who is a CATV subscriber and a billing service subscriber of a payment intermediary;
(b) displaying data representative of the e-bill on a TV set of the CATV subscriber,
(c) receiving a reply from the CATV subscriber authorizing or rejecting payment of the e-bill; and
(d) conveying a reply authorizing payment to the payment intermediary.

30. The method according to claim 29, further including registering with the payment intermediary prior to receiving the e-bill.

31. A system to effecting billing via a CATV infrastructure, the system comprising:
an input port for receiving from a payment intermediary an e-bill incurred with respect to a product or service rendered by an invoicing party, which invoicing party is not a CATV service provider, to a customer who is a CATV subscriber and a billing service subscriber of a payment intermediary;
a data port for conveying data representative of the e-bill for display on a TV set of the CATV subscriber,
a user interface for receiving a reply from the CATV subscriber authorizing or rejecting payment of the e-bill; and
an output port coupled to the user interface for conveying a reply authorizing payment to the payment intermediary.

32. The system according to claim 31, wherein the user interface is further configured to receive a user command for registering the CATV subscriber with the payment intermediary.
